(19) United States
(12) Patent Application Publication
(10) Pub. No.: US 2023/0244824 A1
(43) Pub. Date: Aug. 3, 2023

(54) FIREWALL FOR ON-CHIP SIGNALING

(71) Applicant: BAE Systems Information and Electronic Systems Integration Inc., Nashua, NH (US)

(72) Inventors: David D. Moser, Haymarket, VA (US); Daniel L. Stanley, Warrenton, VA (US); Tate J. Keegan, Merrimack, NH (US); Joshua C. Schabel, Apex, NC (US); Sheldon L. Grass, Chester, NH (US)

(73) Assignee: BAE Systems Information and Electronic Systems Integration Inc., Nashua, NH (US)

(21) Appl. No.: 17/591,699

(22) Filed: Feb. 3, 2022

(51) Int. Cl. G06F 21/85; G06F 12/14

(52) U.S. Cl. CPC G06F 21/85; G06F 12/1458; G06F 2212/1052

(57) ABSTRACT

An on-chip firewall circuit for providing secure on-chip communication is disclosed. The firewall circuit includes a configurable table of port IDs along with a configurable setting for each port ID to either provide the corresponding port ID with open access to the components of a secure enclave (SE) module or restricted access. If access is restricted, then the command is rerouted to a portion of the secure memory within the SE module, where it can be read only via a secure processing device within the SE module. The secure processing device may require additional verification of the port ID before executing the command stored within the secure memory. In this way, unsecure devices from outside of the SE module can be configured to have no direct access to any of the components within the SE module.

### BACKGROUND

Semiconductor design applications are increasingly using several chips and/or several different hardware modules together on the same chip or across different chips (chip set) in a system-on-chip (SoC) type environment. Signals typically pass between components within a given chip with minimal security requirements. However, this opens the possibility for harmful or other rogue commands to be issued from within the chip, potentially jeopardizing sensitive data stored in or coupled with the chip. Accordingly, there are many non-trivial issues with regards to protecting the integrity of data and/or hardware modules of complex integrated circuit chips.

### BRIEF DESCRIPTION OF THE DRAWINGS

Features and advantages of embodiments of the claimed subject matter will become apparent as the following Detailed Description proceeds, and upon reference to the Drawings, in which:

FIG. 1 illustrates a block diagram of an example system-level chip environment including a secure enclave (SE) circuit, in accordance with an embodiment of the present disclosure;

FIG. 2 illustrates a block diagram of an example SE circuit, in accordance with an embodiment of the present disclosure;

FIG. 3 illustrates a block diagram of an example bridge core for use within the SE circuit of FIG. 2 and that includes both a firewall circuit and a master control circuit, in accordance with some embodiments of the present disclosure;

FIG. 4 highlights various operations performed by the SE circuit of FIGS. 2 and 3, during the reception of a restricted command, in accordance with some embodiments of the present disclosure;

FIG. 5 is a flow chart of an example method for providing secure data transfer within an integrated circuit chip or chip set, in accordance with some embodiments of the present disclosure; and

FIG. 6 illustrates a block diagram of an example computing platform that may include the SE circuit of FIG. 2 or 3, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

An on-chip firewall circuit for providing secure on-chip communication is disclosed. Such a circuit may be used, for example, within a secure enclave (SE) module that includes hardware devices and memory device(s) that that provide a degree of security against malicious activity. A secure memory within the SE module may be used to store sensitive data. According to some embodiments, the firewall circuit includes a configurable table of port IDs along with a configurable setting for each port ID to either provide the corresponding port ID with open access to the components of the SE module or restricted access. If restricted access is provided for a command from a given port ID, then the command is rerouted to a portion of the secure memory within the SE module, where it can be read only via a secure processing device within the SE module. The secure processing device may require additional verification of the port ID before executing the command stored within the secure memory. In the case of a request for data from the secure memory, a secure processor will fetch the requested data and write the data out to an unsecure memory. In this way, unsecure devices from outside of the SE module can be configured to have no direct access to any of the components within the SE module. Additionally, the table of port IDs and the classification of each port ID as either having restricted or open access to the SE module, can be reconfigured to provide chip-level adaptability and flexibility. Numerous embodiments and variations will be appreciated in light of this disclosure.

### General Overview

System-on-Chip (SoC) designs may use one or more signal buses to route signals between various on-chip modules and circuit blocks within a given chip. The execution of such on-chip commands between components of the same system typically has little to no security associated with it, as such commands are considered to be secure as they originate from the same system environment. However, this is increasingly becoming less true as different components within a system-level integrated circuit chip or chip set can be compromised by external bad actors intent on accessing secure information, installing a virus, disrupting functionality, and/or harming any of the SoC circuits. Systems at the higher personal computer level are protected by such attacks typically with a firewall to prevent unwanted access to a personal computer via the Internet. However, no such firewall protection exists at the chip-level to provide protection between circuit blocks of the same SoC or across coupled SoCs.

Thus, and according to an embodiment of the present disclosure, an on-chip firewall circuit is provided herein that acts as a gatekeeper to protect secure components of a SoC from one or more unsecure components of the SoC. In some such embodiments, the firewall circuit includes hardware that is definable using a hardware description language (HDL) such as Very High-Speed Integrated Circuit Hardware Description Language (VHDL) or Verilog. The firewall circuit may be included as part of a secure enclave (SE) circuit, which includes secure hardware blocks, such as at least a secure processor and a secure memory. Access to any of the components of the SE circuit from any unsecure device outside of the SE circuit is designed to go through the firewall circuit that is configured to determine if the request received from the unsecure device should be allowed, or not. According to some embodiments, the request can be either denied access, granted open access, or granted restricted access. When granted restricted access, the unsecure request is instead processed by the secure processor within the SE circuit (assuming any further verification is approved) such that the unsecure device is not provided any access to any other part of the SE circuit except for the firewall circuit. Numerous embodiments and variations will be appreciated in light of this disclosure.

In an embodiment, a method of providing secure data transfer within an integrated circuit chip or chip set includes receiving a command issued from a processing device within the integrated circuit chip or chip set; comparing a source ID associated with the processing device to a plurality of stored IDs; and in response to the source ID being found among the plurality of stored IDs, identifying the source ID as having a restricted access or an open access. In response to the source ID having a restricted access, the method includes redirecting an address associated with the command to a portion of a secure memory, reading the portion of the secure memory using a secure processing device, and executing the command in the portion of the secure memory, using the secure processing device; and in response to the source ID having an open access, the method includes executing the command using the processing device that issued the command.

In another embodiment, a firewall circuit includes a stub circuit configured to receive an unsecure on-chip signal from an unsecure source, and to identify a source ID corresponding to the unsecure on-chip signal. The firewall circuit further includes a memory configured to hold at least one stored ID, and a state machine configured to transmit a secure on-chip signal to a secure source in response to a secure processing device verifying an access right associated with the unsecure on-chip signal. The access right is verified when the source ID corresponds to at least one of the stored IDs.

In another embodiment, a SoC includes a network interface configured to route signals between a plurality of on-chip hardware blocks, a firewall circuit coupled to the network interface and configured to receive an unsecure on-chip signal from an unsecure source and to transmit a secure on-chip signal, via the network interface, to a secure source coupled to the network interface, a secure processing device coupled to the network interface, and a secure memory coupled to the network interface. The firewall circuit includes a stub circuit configured to receive the unsecure on-chip signal from the unsecure source, and to identify a source ID corresponding to the unsecure on-chip signal. The firewall circuit further includes a memory configured to hold at least one stored ID, and a state machine configured to transmit the secure on-chip signal to the secure source in response to the secure processing device verifying an access right associated with the unsecure on-chip signal. The access right is verified when the source ID corresponds to at least one of the stored IDs.

### On-Chip Signaling Environment

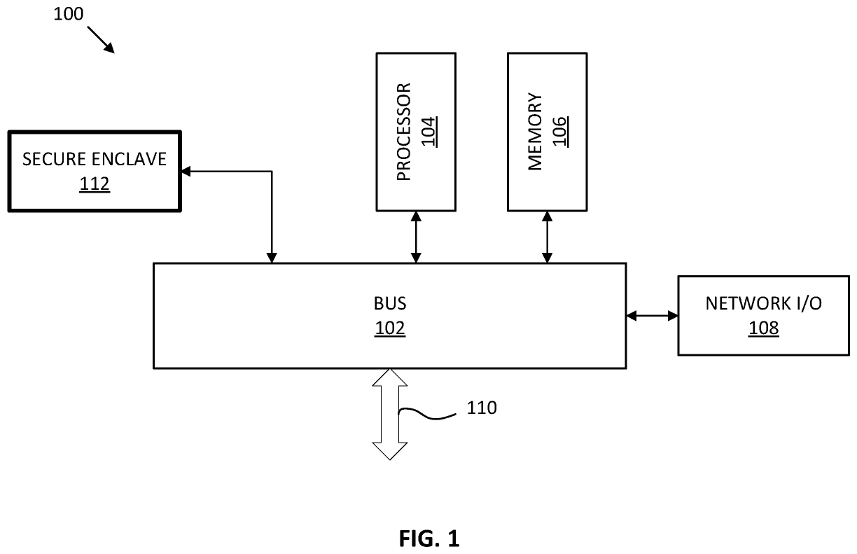

FIG. 1 illustrates an example digital signaling environment 100, according to an embodiment. Digital signaling environment 100 may represent various circuit blocks or modules within a SoC and/or a multichip package. Accordingly, the various circuit blocks described herein may be implemented using an integrated circuit fabricated on a single chip, across multiple chips within a same chip package, or across chips in different chip packages.

Digital signaling environment 100 may include some form of signal bus 102 that is designed to route signals between various circuit blocks. Various circuit blocks may be coupled to one or more ports of signal bus 102, such as a processor 104, memory 106, or a network I/O circuit 108. Any other circuits or other signal buses may also be coupled to signal bus 102 via bus connection 110.

Processor 104 may represent any number of processing devices implemented as any number of processor cores. Processor 104 may be any type of processor, such as, for example, a micro-processor, an embedded processor, a digital signal processor (DSP), a graphics processor (GPU), a network processor, a field programmable gate array (FPGA), application-specific integrated circuit (ASIC) or other device configured to execute code.

Memory 106 can be implemented using any suitable type of digital storage including, for example, flash memory and/or random-access memory (RAM). In some embodiments, memory 106 may include various layers of standard memory hierarchy and/or standard memory caches. Memory 106 may be implemented as a volatile memory device such as, but not limited to, a RAM, dynamic RAM (DRAM), or static RAM (SRAM) device.

Network I/O 108 may represent any type of wired and/or wireless network interface designed to receive and transmit signals across a network. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

According to some embodiments, each of processor 104, memory 106, network I/O 108 and any other devices coupled to bus 102 via bus connection 110 may be designated as being unsecure sources. A secure enclave (SE) module 112 may also be coupled to bus 102 with the various circuit components within SE module being designated as secure sources (as represented by the bolder lines). A secure source or secure device may be any circuit or device that can be fully trusted while an unsecure source or device may be any circuit or device that has the possibility of having its security compromised, and thus cannot be fully trusted. Unsecure sources within signaling environment 100 may wish to access one or more of the components (e.g. secure memory) within SE module 112. Typically, rudimentary security may have been imposed in such situations to basically ensure that the request was being received from the correct port of bus 102. However, greater security may be required to ensure that a compromised unsecure source connected to bus 102 is identified and denied access to SE module 112.

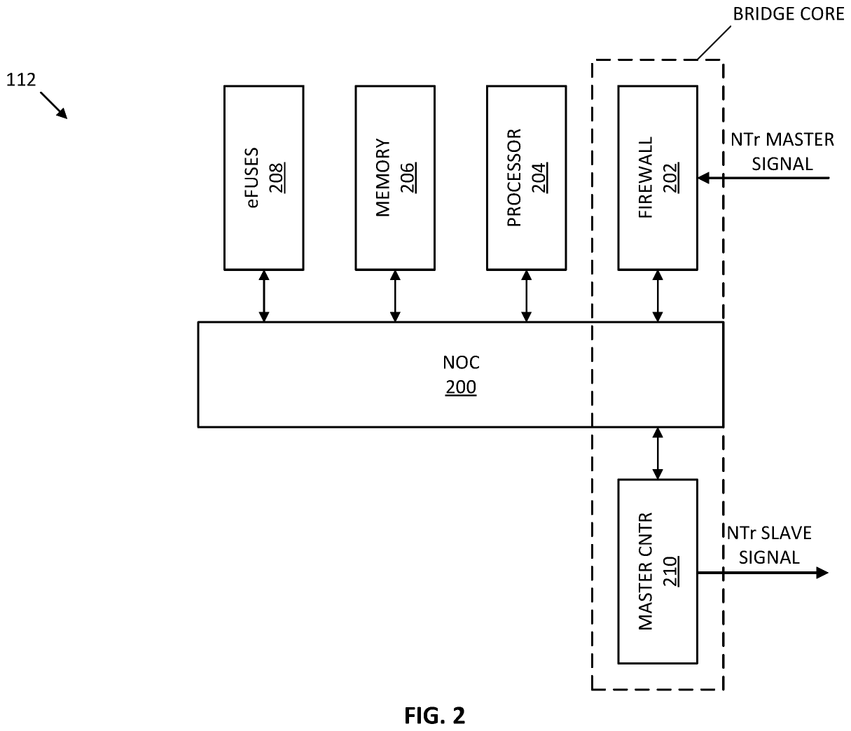

FIG. 2 illustrates a more detailed block diagram of SE module 112, according to some embodiments. SE module 112 may include various hardware devices or circuits coupled to a network-on-chip (NOC) 200. For example, SE module 112 can include a firewall circuit 202, a secure processor 204, a secure memory 206, electronic fuses 208, and a master control circuit 210 each coupled to NOC 200.

According to some embodiments, NOC 200 is a router-based packet switching network that may span both synchronous and asynchronous clock domains. In other embodiments, NOC 200 uses unclocked asynchronous logic. In any case, NOC 200 can allow each coupled device to operate with its own clock domain. In some other embodiments, a standard signal bus is used in place of NOC 200.

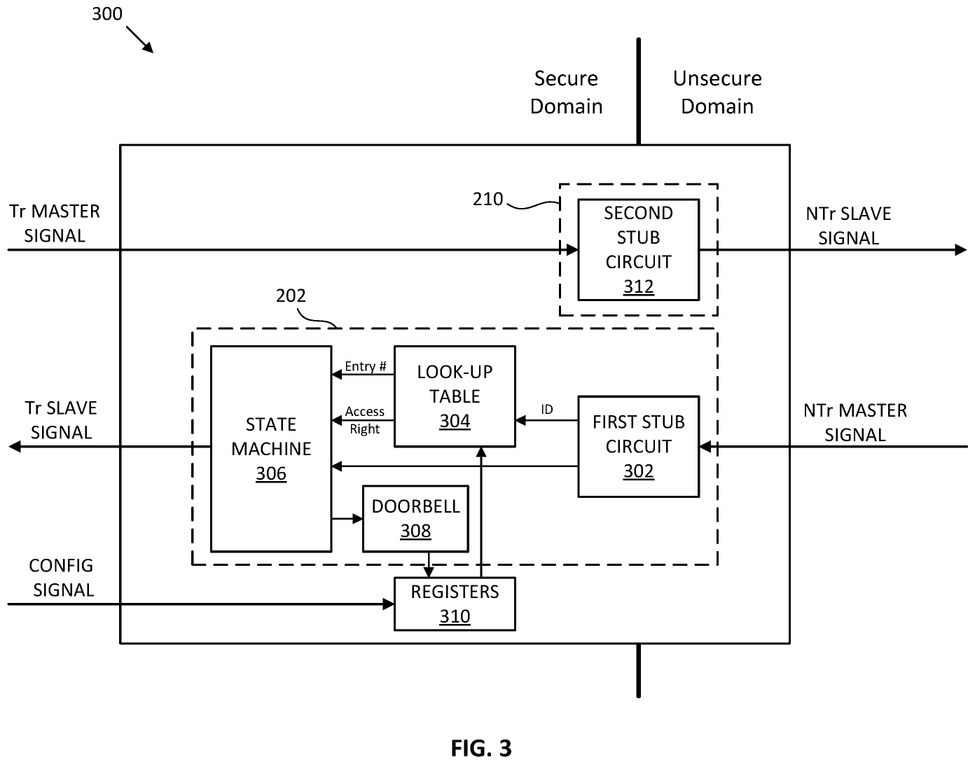

According to some embodiments, firewall circuit 202 receives various commands from one or more unsecure devices, represented as non-trusted master signals (e.g., NTr master signal). These unsecure commands may be read requests for data stored on secure memory 206, or they may be requests to change some feature within SE module 112, such as changing any of the digital fuses within electronic fuses 208. Accordingly, firewall circuit 202 acts as a gatekeeper of sorts to ensure that any commands being received from unsecure devices are first verified before they are executed. This verification process may include allowing the unsecure device to have open access to one or more devices within SE module 112 or allowing the unsecure device restricted access by executing the received command instead with secure processor 204 of SE module 112. Further details of firewall circuit 202 are provided with reference to FIG. 3. Each of secure processor 204 and secure memory 206 may have similar architectures to processor 104 and memory 106, respectively.

According to some embodiments, electronic fuses 208 represent digitally configurable circuits that may be used for setting private key codes. Accordingly, the state of electronic fuses 208 may be used to set authentication parameters for certain unsecure devices, in some embodiments. Other uses for electronic fuses 208 will be appreciated.

Master control circuit 210 represents the conditioning and transmission of on-chip master signals sent by SE module 112 to unsecure slave devices, according to some embodiments. Such signals are represented in FIG. 2 as non-trusted slave signals (e.g., NTr slave signal). For example, secure processor 204 may be instructed to retrieve data from secure memory 206 and write this data out to an unsecure device (such as memory 106). The write command may be sent via master control circuit 210 out from SE module 112. In some embodiments, master control circuit 210 is a part of firewall circuit 202. Master control circuit 210 and firewall circuit 202 can be collectively referred to as a bridge core.

FIG. 3 illustrates a block diagram of an example bridge core 300 that includes both firewall circuit 202 and master control circuit 210, according to an embodiment. The various signals passing into and out of bridge core 300 are designated as either secure signals (within the secure domain of SE module 112) or unsecure signals (within the unsecure domain outside of the SE module 112). According to some embodiments, firewall circuit 202 acts as a non-trusted bridge circuit while master control circuit 210 acts as a trusted bridge circuit.

According to some embodiments, commands are received from one or more of the unsecure devices (e.g., NTr master signals) at a first stub circuit 302 within firewall circuit 202. As used herein, stub circuits are used to perform signal conditioning for signals passing between the unsecure domain and the secure domain. In some examples, first stub circuit 302 is configured for asynchronous clocking. According to an embodiment, first stub circuit 302 is configured to determine an ID associated with the received command. The ID may be related to a port that the command is received from on a system bus, such as bus 102. In one example, first stub circuit 302 strips the ID bits from the received command and passes the ID on to be compared with stored IDs in a look-up table (LUT) 304. The comparison may be performed using secure processor 204. Other logic structures used to store the IDs may be used in place of LUT 304. According to some embodiments, first stub circuit 302 is implemented as a combination of various logic gates and may be incorporated into its own application specific integrated circuit (ASIC).

According to some embodiments, LUT 304 stores a given number of local device IDs that may correspond to one or more known ports of bus 102. The access rights for each of the stored IDs may be reconfigured using secure processor 204. Those access rights may include an “open” access or a “restricted” access. If a received ID is not found among the list of stored IDs, then the received command is blocked access to any part of SE module 112, and a response may be provided to indicate that access was blocked. As discussed above, open access may be given to those IDs which are secure, and thus the received command is given access to one or more devices within SE module 112. For example, a read command provided by a processor outside of SE module 112 may be given the ability to directly access secure memory 206 if it has been provided open access. Restricted access may be given to those IDs that represent devices or ports that could be compromised and thus may not be fully trusted. As a result, such commands are not given the ability to directly access any of the devices within SE module 112. Instead, restricted commands are intercepted and written to a portion of secure memory 206, where such commands can then be later accessed and executed by secure processor 204. Before executing the redirected commands, secure processor 204 may perform any additional authentication procedures with the received command, such as public/private keying. For example, a restricted read command provided by a processor outside of SE module 112 (e.g., requesting data stored on secure memory 206) would not be allowed access to secure memory 206, but would instead be redirected to be written on a dedicated portion of secure memory 206. The read command would then be accessed by secure processor 204 and executed to read the data from secure memory 206. The data would be sent out (via master control circuit 210) to be written in an unsecure memory location. In this way, the unsecure processor can access the requested data via the unsecure memory without ever being granted direct access to the data within SE module 112.

According to some embodiments, the designation between open and restricted access for a given ID is provided as a bit or set of bits that may be used to indicate that access is restricted. That is, if a given bit or set of bits is set, then access is restricted, otherwise the access is open, according to one example.

According to some embodiments, a state machine 306 receives the requested command from first stub circuit 302, along with the access right and LUT entry number associated with the command. Depending on whether the access right is open or restricted, state machine 306 directs the command to the proper location within SE module 112 as a trusted slave signal. For example, commands that are classified as being open may be routed directly to the requested device within SE module 112. However, commands that are classified as restricted are routed to an address in secure memory 206. The re-routed address may be formed via concatenation of bits from a restricted base address (RBA) register, the ID associated with the command, and the lower addresses from the unsecure device, according to some embodiments. According to some embodiments, one of the bits of the re-routed address may be used to provide a doorbell request, as represented by doorbell 308. The doorbell request acts as an interrupt signal to secure processor 204 to alert secure processor 204 that a command with restricted access has been written to secure memory 206 along with the location of the command within secure memory 206, according to some embodiments. In this way, secure processor 204 can be directed to execute the command quickly.

According to some embodiments, bridge core 300 includes one or more registers 310 that are designed to be reconfigurable and accessible by secure processor 204 via one or more config signals. Secure processor 204 may reconfigure and access various operations of bridge core 300 via any of registers 310. In one example, restricted base address (RBA) registers may be used to designate both high and low order bits in the re-directed address as shown in the example tables below.

TABLE 1
RBA register for setting low address bits
Restricted Base Address Lo

| | | | | Reset |
|---|---|---|---|---|
| Bits | Field Name | Description | Access | State |
| 31:14 | Base | This field shall provide the low | RW | 0x0000 |
| | Address(31:14) | order address bits for restricted | | |
| | | accesses. | | |
| 13:02 | Reserved | | RO | 0x000 |
| 01:00 | Window | This field shall determine the | RW | 00 |
| | Size(1:0) | size of the restricted address | | |
| | | window. | | |
| | | 00-1 KB | | |
| | | 01-2 KB | | |
| | | 10-4 KB | | |
| | | 11-8 KB | | |

TABLE 2
RBA register for setting high address bits
Restricted Base Address Hi

| | | | | Reset |
|---|---|---|---|---|
| Bits | Field Name | Description | Access | State |
| 31:00 | Base | This field shall provide the | RW | 0x00000000 |
| | Address(63:32) | high order AXI address bits | | |
| | | for restricted accesses. | | |

In the example registers above, the restricted address width is 64 bits wide. The first RBA register uses the lowest 2 bits to determine the window size of the restricted address and bits 14-31 form part of the address. The second RBA register uses each of its 32 bits to form the higher 32 bits of the address. Other bit arrangements are possible as well with this being just one example of using two registers to set the re-directed address for a restricted command.

In some embodiments, registers 310 includes a LUT register for providing the ID entries and their associated access rights. An example of such a LUT register is provided below.

TABLE 3
ID LUT register
ID Look Up Table 0:15

| | | | | Reset |
|---|---|---|---|---|
| Bits | Field Name | Description | Access | State |
| 31:N¹+2 | Reserved | | RO | 0 |
| N¹+1:02 | ID(N¹−1:0) | This field shall contain the ID | RW | 0 |
| | | match for the Non-Trusted | | |
| | | access. | | |
| 01 | Restricted | This bit shall indicate that the | RW | 0 |
| | | access is Restricted. | | |
| | | 0-Open | | |
| | | 1-Restricted | | |
| 00 | Valid | This bit shall indicate that the | RW | 0 |
| | | LUT entry is valid. | | |
| | | 0-Not valid | | |
| | | 1-Valid | | |

In this example, the least significant bit indicates whether the entry in the LUT is valid while the next bit indicates whether the ID entry has restricted access (set as 1) or open access (set as 0) The various stored ID matches are provided on the remaining bits in the register.

Various other registers may be used as well to configure other aspects of bridge core 300, such as the total number of address bits passed across the trusted bridge, the total number of address bits passed across the non-trusted bridge, the width of the data bus associated with the received on-chip command signals, the width of the ID field as used within SE module 112 across NOC 200, and the width of the ID field as used across bus 102 outside of SE module 112, to name a few examples. It should be understood that registers 310 may also be included within firewall 202 or may be considered a separate module from bridge core 300.

According to some embodiments, trusted master signals received from within SE module 112 (such as requests to write data to unsecure memory devices outside of SE module 112) are passed through a second stub circuit 312 before being transmitted as on-chip non-trusted slave signals to one or more unsecure devices. Second stub circuit 312 may operate in a similar asynchronous fashion to first stub circuit 302. According to some embodiments, second stub circuit 312 is implemented as a combination of various logic gates and may be incorporated into its own application specific integrated circuit (ASIC).

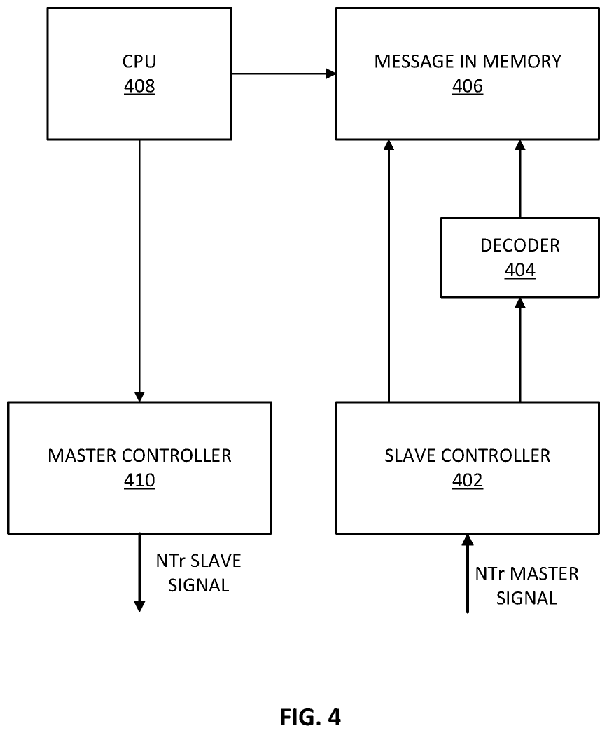

FIG. 4 illustrates a block diagram highlighting a portion of the operations performed in SE module 112 during the reception of a restricted command, according to an embodiment. A non-trusted master signal is received at a slave controller 402, which may be similar to a non-trusted bridge or first stub circuit 302 discussed above. Slave controller 402 is designated as a “slave” because it represents a device that is receiving the command issued by another device. In one example, the non-trusted master signal represents a read request issued by an unsecure processor for data stored on secure memory 206 of SE module 112.

Slave controller 402 passes the received command along to a decoder block 404 that is designed to strip off the ID bits from the command and use those bits as part of a re-directed address to store as a message in memory 406. According to some embodiments, the message is stored within secure memory 206 of SE module 112. Note that re-directing the command to be written in a dedicated portion of the secure memory is performed in response to the ID associated with the command being flagged as restricted, according to some embodiments.

According to some embodiments, a doorbell interrupt signal is provided to a secure CPU 408 upon writing the message in memory 406. In response, secure CPU 408 reads the message left for it in the memory and executes the command (assuming any further authentication procedures have been passed). In the illustrated example, the command left in memory is a read command for data held within secure memory 206. Accordingly, secure CPU 408 retrieves the requested data and transmits the data to a slave unsecured memory device via master controller 410 as a non-trusted slave signal. Master controller 410 is designated as a “master” because it represents a device that is issuing a command to another device. According to some embodiments, master controller 410 is similar to a trusted bridge or second stub circuit 312 discussed above.

Methodology

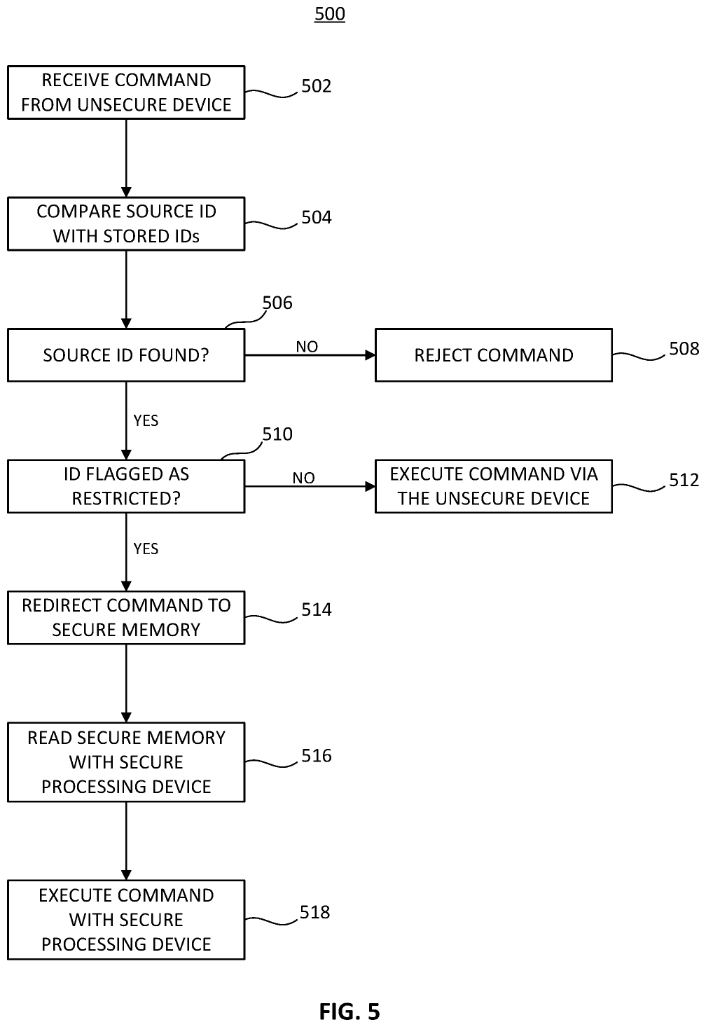

FIG. 5 illustrates an example flow diagram for a method 500 of using a firewall to provide secure on-chip communication between devices, according to an embodiment. Method 500 may be performed, for example, in whole or in part by SE module 112 and/or firewall circuit 202. The operations, functions, or actions described in the respective blocks of example method 500 may be stored as computer-executable instructions in a non-transitory computer-readable medium, such as a memory and/or a data storage of a computing system. In some embodiments, circuits and/or circuit modules configured to execute the operations, functions, or actions described in the respective blocks of example method 500 may be implemented using a hardware programming language such as VHDL or Verilog. As will be further appreciated in light of this disclosure, for this and other processes and methods disclosed herein, the functions performed in method 500 may be implemented in a differing order. Additionally, or alternatively, two or more operations may be performed at the same time or otherwise in an overlapping contemporaneous fashion. Of note is the fact that all operations of method 500 may be performed on-chip or within the same SoC package using all on-chip signals, such as AXI signals or Wishbone signals, to name a few examples. AXI refers to Advanced eXtensible Interface, and is part of a standard microcontroller bus architecture that defines a parallel high-performance, synchronous, high-frequency, multi-master, multi-slave communication interface, designed for on-chip communication. Likewise, Wishbone refers to an open source hardware computer bus for on-chip communication.

Method 500 begins with block 502 where a command is received from an unsecure source. According to some embodiments, the command is received at a firewall circuit within a SE module. The command may be an on-chip signal such as an AXI signal. In some examples, the received command is a request for data from a secure memory within the SE module. In some other examples, the received command is a request to change the state of one or more registers, fuses, and/or memory blocks within the SE module. In any case, the command is received from a device outside of the SE module and is thus designated as being received from an unsecure source, according to some embodiments.

At block 504, a source ID associated with the received command is compared to a list of stored IDs, according to an embodiment. The source ID may have a length of any number of bits and be related to a port on a system or chip bus where the command was issued from. In some embodiments, the source ID is represented with four bits allowing for 16 different source ID combinations.

Various stored IDs may be arranged in a look-up-table (LUT) or other type of logical construct that also includes an indication of whether each of the stored IDs has restricted or open access to SE module 112. In some embodiments, one or more bits are assigned for each ID entry to indicate whether the associated ID has restricted or open access to the SE module. In some embodiments, the one or more bits may also be used to indicate that a listed ID has blocked access (e.g., denied entry to the SE module). The source ID may be compared with the stored IDs using, for example, a secure processor within the SE module.

At block 506, a determination is made regarding whether the source ID is found among the stored IDs, according to an embodiment. If the source ID is not found among the stored IDs, then the command associated with the source ID is rejected at block 508. According to some embodiments, a message is sent back to the source that issued the command to indicate that access to the SE module has been blocked. The message may be as simple as a few bits coded to indicate a blocked request.

If the source ID is found among the stored IDs, then a determination is made regarding whether the matching stored ID is flagged as being restricted at block 510. As discussed above, one or more bits may be assigned to designate whether a stored ID is restricted. In one example, if the one or more bits are not set in a way that indicates restricted access, then the access is open and the method proceeds to block 512. The command is executed via the unsecure device that issued the command to either read data from the secure memory within the SE module or reconfigure some aspect of the SE module.

If the matching stored ID is flagged as being restricted, then the command is redirected to a portion of the secure memory at block 514. The memory address used for the redirected command may be a concatenation of bits from a restricted base address (RBA) register, the source ID associated with the command, and the lower address bits from the unsecure device that issued the command, according to some embodiments. According to some embodiments, the secure processor within the SE module may be alerted to the fact that the command has been written to the secure memory using an interrupt signal (e.g., a doorbell). The secure processor may also be provided with the address in the secure memory where the command has been stored.

At block 516, the secure processor accesses the command stored in the secure memory. As part of this operation, or immediately before this operation, the secure processor may perform any number of other authentication techniques to verify the trustworthiness of the source that issued the command. These authentication techniques may include public/private keying, message format, or any type of password, to name a few examples.

At block 518, the secure processor executes the command initially issued by an unsecure source outside of the SE module. In this way, the unsecure source having restricted access is blocked from directly accessing any part of the SE module—rather its command is instead executed using the secure processor within the SE module. In some examples, the command is a request for data in which case the secure processor reads the requested data and writes the data out to an unsecure memory device to be accessed by the unsecure source outside of the SE module. In some other examples, the command is a request to reconfigure some portion of the SE module (e.g., reconfigure one or more electronic fuses or other gate logic) in which case the reconfiguration is performed using the secure processor within the SE module.

### Example Computing Platform

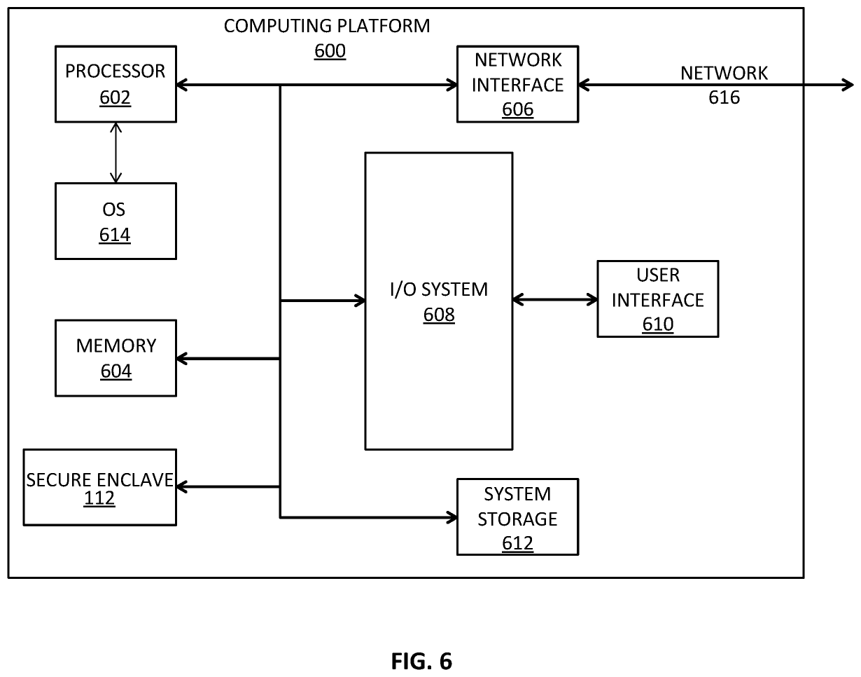

FIG. 6 illustrates an example computing platform 600 that may include SE module 112, in accordance with certain embodiments of the present disclosure. In some embodiments, computing platform 600 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments. As noted above, SE module 112 may include on an-chip firewall circuit configured to control access rights to the SE module for any other components outside of the SE module.

In some embodiments, computing platform 600 may comprise any combination of a processor 602, a memory 604, SE module 112, a network interface 606, an input/output (I/O) system 608, a user interface 610, and a storage system 612. In some embodiments, SE module 112 includes at least its own secure processor and secure memory. As can be further seen, a bus and/or interconnect is also provided to allow for communication between the various components listed above and/or other components not shown. Computing platform 600 can be coupled to a network 616 through network interface 606 to allow for communications with other computing devices, platforms, or resources. Other componentry and functionality not reflected in the block diagram of FIG. 6 will be apparent in light of this disclosure, and it will be appreciated that other embodiments are not limited to any particular hardware configuration.

Processor 602 can be any suitable processor and may include one or more coprocessors or controllers to assist in control and processing operations associated with computing platform 600. In some embodiments, processor 602 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

Memory 604 can be implemented using any suitable type of digital storage including, for example, flash memory and/or random access memory (RAM). In some embodiments, memory 604 may include various standard layers of memory hierarchy and/or standard memory caches. Memory 604 may be implemented as a volatile memory device such as, but not limited to, a RAM, dynamic RAM (DRAM), or static RAM (SRAM) device. Storage system 612 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage system 612 may comprise technology to increase the storage performance enhanced protection for valuable digital media when multiple hard drives are included.

Processor 602 may be configured to execute an Operating System (OS) 614 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with computing platform 600, and therefore may also be implemented using any suitable existing or subsequently-developed platform.

Network interface 606 can be any appropriate network chip or chipset which allows for wired and/or wireless connection between other components of computing platform 600 and/or network 616, thereby enabling computing platform 600 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 608 may be configured to interface between various I/O devices and other components of computing platform 600. I/O devices may include, but not be limited to, a user interface 610. User interface 610 may include devices (not shown) such as a display element, touchpad, keyboard, mouse, and speaker, etc. I/O system 608 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 602 or any chipset of computing platform 600.

It will be appreciated that in some embodiments, the various components of the computing platform 600 may be combined or integrated in a system-on-a-chip (SoC) architecture. In some embodiments, the components may be hardware components, firmware components, software components or any suitable combination of hardware, firmware or software.

In various embodiments, computing platform 600 may be implemented as a wireless system, a wired system, or a combination of both. When implemented as a wireless system, computing platform 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, computing platform 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Some of the embodiments discussed herein may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, is a functional apparatus and may comprise, for example, singly or in any combination, hardwired circuitry, programmable circuitry such as one or more computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit chip or chip set, an application-specific integrated circuit (ASIC), a system on-chip (SoC), desktop computers, laptop computers, tablet computers, servers, smart phones, etc. Other embodiments may be implemented as software stored in a machine-readable medium and that can be executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Thus, a circuit or circuitry is a functional physical apparatus that can be any of integrated circuitry, printed circuit board circuitry, gate-level logic, analog and/or digital circuitry, one or more programmed processors or processing entities (e.g., combination of instructions and one or more processors configured to execute those instructions).

### Further Example Embodiments

The following examples pertain to further embodiments, from which numerous permutations and configurations will be apparent.

Example 1 is a firewall circuit that includes a stub circuit configured to receive an unsecure on-chip signal from an unsecure source, and to identify a source ID corresponding to the unsecure on-chip signal. The firewall circuit further includes a memory configured to hold at least one stored ID, and a state machine configured to transmit a secure on-chip signal to a secure source in response to a secure processing device verifying an access right associated with the unsecure on-chip signal. The access right is verified when the source ID corresponds to at least one of the stored IDs.

Example 2 includes the subject matter of Example 1, wherein the unsecure on-chip signal and the secure on-chip signal are Advanced eXtensible Interface (AXI) signals or Wishbone signals.

Example 3 includes the subject matter of Example 1 or 2, wherein the unsecure on-chip signal comprises a read instruction for one or more addresses of a secure memory.

Example 4 includes the subject matter of any one of Examples 1-3, wherein the state machine is configured to transmit the secure on-chip signal to a portion of a secure memory in response to the access right being a restricted access right.

Example 5 includes the subject matter of Example 4, further comprising a doorbell register coupled to the state machine and configured to transmit an interrupt signal to the secure processing device to instruct the secure processing device to read the portion of the secure memory.

Example 6 includes the subject matter of any one of Examples 1-5, wherein the at least one stored ID is arranged in a look-up-table (LUT).

Example 7 includes the subject matter of Example 6, wherein the LUT includes an access right associated with each of the at least one stored IDs.

Example 8 is a system-on-chip (SoC) that includes a network interface configured to route signals between a plurality of on-chip hardware blocks, a firewall circuit coupled to the network interface and configured to receive an unsecure on-chip signal from an unsecure source and to transmit a secure on-chip signal, via the network interface, to a secure source coupled to the network interface, a secure processing device coupled to the network interface, and a secure memory coupled to the network interface. The firewall circuit includes a stub circuit configured to receive an unsecure on-chip signal from an unsecure source, and to identify a source ID corresponding to the unsecure on-chip signal. The firewall circuit further includes a memory configured to hold at least one stored ID, and a state machine configured to transmit a secure on-chip signal to a secure source in response to a secure processing device verifying an access right associated with the unsecure on-chip signal. The access right is verified when the source ID corresponds to at least one of the stored IDs.

Example 9 includes the subject matter of Example 8, wherein a secure enclave (SE) module comprises the network interface, the firewall circuit, the secure processing device, and the secure memory.

Example 10 includes the subject matter of Example 9, comprising a signal bus having a plurality of ports, wherein the SE module is coupled to one port of the plurality of ports and one or more unsecure sources are coupled to corresponding one or more other ports of the plurality of ports.

Example 11 includes the subject matter of any one of Examples 8-10, wherein the unsecure on-chip signal and the secure on-chip signal are AXI signals or Wishbone signals.

Example 12 includes the subject matter of any one of Examples 8-11, wherein the unsecure on-chip signal comprises a read instruction for one or more addresses of the secure memory.

Example 13 includes the subject matter of any one of Examples 8-12, wherein the state machine is configured to transmit the secure on-chip signal to a portion of the secure memory in response to the access right being a restricted access right.

Example 14 includes the subject matter of Example 13, wherein the firewall circuit comprises a doorbell register coupled to the state machine and configured to transmit an interrupt signal to the secure processing device to instruct the secure processing device to read the portion of the secure memory.

Example 15 includes the subject matter of any one of Examples 8-14, wherein the at least one stored ID is arranged in a look-up-table (LUT).

Example 16 includes the subject matter of Example 15, wherein the LUT includes an access right associated with each of the at least one stored IDs.

Example 17 includes the subject matter of any one of Examples 8-16, wherein the secure processing device is configured to access the at least one stored ID and to reconfigure the at least one stored ID.

Example 18 is a method of providing secure data transfer within an integrated circuit chip or chip set. The method includes receiving a command issued from a processing device within the integrated circuit chip or chip set; comparing a source ID associated with the processing device to a plurality of stored IDs; and in response to the source ID being found among the plurality of stored IDs, identifying the source ID as having a restricted access or an open access. In response to the source ID having the restricted access, the method includes redirecting an address associated with the command to a portion of a secure memory, reading the portion of the secure memory using a secure processing device, and executing the command in the portion of the secure memory, using the secure processing device. In response to the source ID having the open access, the method includes executing the command using the processing device that issued the command.

Example 19 includes the subject matter of Example 18, wherein the command is an AXI signal or a Wishbone signal.

Example 20 includes the subject matter of Example 18 or 19, wherein the command comprises a read or write instruction for one or more addresses of the secure memory.

Example 21 includes the subject matter of any one of Examples 18-20, wherein the command comprises a read instruction for one or more addresses of the secure memory, and executing the command in the portion of the secure memory comprises reading data within the one or more addresses of the secure memory, using the secure processing device, and writing the data to an unsecure memory, using the secure processing device.

Example 22 includes the subject matter of any one of Examples 18-21, wherein the plurality of stored IDs are arranged in a look-up-table (LUT).

Example 23 includes the subject matter of Example 22, wherein the LUT includes an indication for each of the plurality of stored IDs of whether a given stored ID is restricted.

Example 24 includes the subject matter of any one of Examples 18-23, wherein, in response to the source ID having restricted access, the method comprises issuing an interrupt to the secure processing device to instruct the secure processing device to read the portion of the secure memory.

Example 25 includes the subject matter of any one of Examples 18-24, comprising reconfiguring one or more of the plurality of stored IDs using the secure processing device.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

What is claimed is:

1. A firewall circuit, comprising:
a stub circuit configured to receive an unsecure on-chip signal from an unsecure source, and to identify a source ID corresponding to the unsecure on-chip signal,
a memory configured to hold at least one stored ID, and
a state machine configured to transmit a secure on-chip signal to a secure source in response to a secure processing device verifying an access right associated with the unsecure on-chip signal, the access right being verified when the source ID corresponds to at least one of the stored IDs.

2. The firewall circuit of claim 1, wherein the unsecure on-chip signal and the secure on-chip signal are Advanced eXtensible Interface (AXI) signals or Wishbone signals.

3. The firewall circuit of claim 1, wherein the unsecure on-chip signal comprises a read instruction for one or more addresses of a secure memory.

4. The firewall circuit of claim 1, wherein the state machine is configured to transmit the secure on-chip signal to a portion of a secure memory in response to the access right being a restricted access right.

5. The firewall circuit of claim 4, further comprising a doorbell register coupled to the state machine and configured to transmit an interrupt signal to the secure processing device to instruct the secure processing device to read the portion of the secure memory.

6. The firewall circuit of claim 1, wherein the at least one stored ID is arranged in a look-up-table (LUT).

7. The firewall circuit of claim 6, wherein the LUT includes an access right associated with each of the at least one stored IDs.

8. A system-on-chip (SoC), comprising:
a network interface configured to route signals between a plurality of on-chip hardware blocks;
a firewall circuit coupled to the network interface and configured to receive an unsecure on-chip signal from an unsecure source and to transmit a secure on-chip signal, via the network interface, to a secure source coupled to the network interface;
a secure processing device coupled to the network interface; and
a secure memory coupled to the network interface;
wherein the firewall circuit comprises
a stub circuit configured to receive the unsecure on-chip signal, and to identify a source ID corresponding to the unsecure on-chip signal,
a memory configured to hold at least one stored ID, and
a state machine configured to transmit the secure on-chip signal to the secure source in response to the secure processing device verifying an access right associated with the unsecure on-chip signal, the access right being verified when the source ID corresponds to at least one of the stored IDs.

9. The SoC of claim 8, wherein a secure enclave (SE) module comprises the network interface, the firewall circuit, the secure processing device, and the secure memory.

10. The SoC of claim 9, comprising a signal bus having a plurality of ports, wherein the SE module is coupled to one port of the plurality of ports and one or more unsecure sources are coupled to corresponding one or more other ports of the plurality of ports.

11. The SoC of claim 8, wherein the unsecure on-chip signal and the secure on-chip signal are AXI signals or Wishbone signals.

12. The SoC of claim 8, wherein the unsecure on-chip signal comprises a read instruction for one or more addresses of the secure memory.

13. The SoC of claim 8, wherein the state machine is configured to transmit the secure on-chip signal to a portion of the secure memory in response to the access right being a restricted access right.

14. The SoC of claim 13, wherein the firewall circuit comprises a doorbell register coupled to the state machine and configured to transmit an interrupt signal to the secure processing device to instruct the secure processing device to read the portion of the secure memory.

15. The SoC of claim 8, wherein the at least one stored ID is arranged in a look-up-table (LUT).

16. The SoC of claim 15, wherein the LUT includes an access right associated with each of the at least one stored IDs.

17. The SoC of claim 8, wherein the secure processing device is configured to access the at least one stored ID and to reconfigure the at least one stored ID.

18. A method of providing secure data transfer within an integrated circuit chip or chip set, the method comprising:
receiving a command issued from a processing device within the integrated circuit chip or chip set;
comparing a source ID associated with the processing device to a plurality of stored IDs;
in response to the source ID being found among the plurality of stored IDs, identifying the source ID as having a restricted access or an open access;
in response to the source ID having the restricted access
redirecting an address associated with the command to a portion of a secure memory,
reading the portion of the secure memory using a secure processing device, and
executing the command in the portion of the secure memory, using the secure processing device; and
in response to the source ID having the open access executing the command using the processing device that issued the command.

19. The method of claim 18, wherein the command comprises a read instruction for one or more addresses of the secure memory, and executing the command in the portion of the secure memory comprises reading data within the one or more addresses of the secure memory, using the secure processing device, and writing the data to an unsecure memory, using the secure processing device.

20. The method of claim 18, wherein, in response to the source ID having restricted access, the method comprises issuing an interrupt to the secure processing device to instruct the secure processing device to read the portion of the secure memory.
